(19) United States
(12) Patent Application Publication
(10) Pub. No.: US 2025/0291646 A1
(43) Pub. Date: Sep. 18, 2025

(54) LEVERAGING LARGE LANGUAGE MODELS TO ORCHESTRATE MICROSERVICES

(71) Applicant: NEC Laboratories America, Inc., Princeton, NJ (US)

(72) Inventors: Kunal Rao, Monroe, NJ (US); Giuseppe Coviello, Robbinsville, NJ (US); Priscilla Benedetti, Perugia (IT); Ciro Giuseppe DeVita, Napoli (IT); Gennaro Mellone, Napoli (IT); Srimat Chakradhar, Manalapan, NJ (US)

(21) Appl. No.: 19/078,462

(22) Filed: Mar. 13, 2025

Related U.S. Application Data
(60) Provisional application No. 63/565,017, filed on Mar. 14, 2024.

(51) Int. Cl. G06F 9/50; G06F 8/30

(52) U.S. Cl. CPC G06F 9/5083; G06F 8/30

(57) ABSTRACT

Systems and methods for leveraging large language models for orchestrating microservices. A cost model and a latency model can be built with a large language model (LLM) based on an instruction prompt that analyzes microservice data of a distributed computing application. The microservice data can be analyzed to learn trigger rules that facilitate placement of microservices at optimal locations within the multi-tiered computing infrastructure based on cost and latency. The microservices can be placed at the optimal locations based on the trigger rules. The LLM can be tuned using feedback from the distributed computing application after placing the microservices at the optimal locations.

### RELATED APPLICATION INFORMATION

This application claims priority to U.S. Provisional App. No. 63/565,017, filed on Mar. 14, 2024, incorporated herein by reference in its entirety.

### BACKGROUND

### Technical Field

The present invention relates to optimizing performance of a distributed computing application and more particularly to leveraging large language models to orchestrate microservices.

### Description of the Related Art

Artificial Intelligence (AI) or machine learning (ML) techniques have proven to be useful in handling system problems. In all these, the required models, sophisticated algorithms, etc. are already built beforehand and incorporated into the system software at the time of deployment. If some model or heuristic changed during operation, then the model has to be rebuilt and re-deployed. Such customization takes substantial time and effort, especially, when these customizations are complex and the system problem spans across multiple tiers of computing.

### SUMMARY

According to an aspect of the present invention, a computer-implemented method is provided for leveraging large language models to orchestrate microservices, including, building a cost model and a latency model by employing a large language model (LLM) based on an instruction prompt that analyzes microservice data of a distributed computing application, analyzing the microservice data with the cost model and the latency model to learn trigger rules that facilitate placement of microservices at optimal locations within a multi-tiered computing infrastructure that balances cost and latency of a workload of the distributed computing application, placing the microservices at the optimal locations based on the trigger rules, and tuning the LLM using feedback from the distributed computing application after placing the microservices at the optimal locations.

According to another aspect of the present invention, a system is provided for leveraging large language models to orchestrate microservices, including, a memory device, one or more processor devices operatively coupled with the memory device to perform operations having, building a cost model and a latency model by employing a large language model (LLM) based on an instruction prompt that analyzes microservice data of a distributed computing application, analyzing the microservice data with the cost model and the latency model to learn trigger rules that facilitate placement of microservices at optimal locations within a multi-tiered computing infrastructure that balances cost and latency of a workload of the distributed computing application, placing the microservices at the optimal locations based on the trigger rules, and tuning the LLM using feedback from the distributed computing application after placing the microservices at the optimal locations.

According to yet another aspect of the present invention, a non-transitory computer program product including a computer-readable storage medium having a program code is provided, wherein the program code when executed on a computer causes the computer to perform building a cost model and a latency model by employing a large language model (LLM) based on an instruction prompt that analyzes microservice data of a distributed computing application, analyzing the microservice data with the cost model and the latency model to learn trigger rules that facilitate placement of microservices at optimal locations within a multi-tiered computing infrastructure that balances cost and latency of a workload of the distributed computing application, placing the microservices at the optimal locations based on the trigger rules, and tuning the LLM using feedback from the distributed computing application after placing the microservices at the optimal locations.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a flow diagram showing a high-level overview of a computer-implemented method for leveraging large language models for orchestrating microservices, in accordance with an embodiment of the present invention;

FIG. 2 is a block diagram showing the relationships between a prompt template, heuristics, and sub-heuristics, in accordance with an embodiment of the present invention;

FIG. 3 is a block diagram showing the relationship between the sub-heuristics and an instruction prompt, in accordance with an embodiment of the present invention;

FIG. 4 is a block diagram showing the relationship between the sub-heuristics and a code snippet, in accordance with an embodiment of the present invention;

FIG. 5 is a block diagram showing a system for leveraging large language models for orchestrating microservices implemented in practical applications, in accordance with an embodiment of the present invention;

FIG. 6 is a block diagram showing an overview of a system for leveraging large language models for orchestrating microservices, in accordance with an embodiment of the present invention;

FIG. 7 is a block diagram showing a system for leveraging large language models for orchestrating microservices (MO-LLM), in accordance with an embodiment of the present invention;

FIG. 8 is a block diagram showing a computer system for leveraging large language models for orchestrating microservices, in accordance with an embodiment of the present invention; and

FIG. 9 is a block diagram showing a structure of deep neural networks for leveraging large language models for orchestrating microservices, in accordance with an embodiment of the present invention.

### DETAILED DESCRIPTION OF PREFERRED EMBODIMENTS

In accordance with embodiments of the present invention, systems and methods are provided for leveraging large language models for orchestrating microservices.

In an embodiment, a cost model and a latency model can be built with a large language model (LLM) based on an instruction prompt that analyzes microservice data of a distributed computing application. The microservice data can be analyzed to learn trigger rules that facilitate placement of microservices at optimal locations within the multi-tiered computing infrastructure based on cost and latency. The microservices can be placed at the optimal locations based on the trigger rules. The LLM can be tuned using feedback from the distributed computing application after placing the microservices at the optimal locations.

Microservices-based real-time stream processing distributed computing applications, especially video analytics applications require different amount of computing power to handle different workloads. For example, for a face recognition video analytics application, the amount of computing power required for a small number of people in the video scene is also small. However, when there are lot of people, then high performance computing power is needed in order to deliver face recognition insights quickly.

Modern infrastructure consists of multiple tiers of computing, including computing capability on devices, computing capability at the edge and on-premises, computing capability in multi-access edge computing in geographically nearby area (MEC) and computing in the cloud. There are pros and cons of computing at each tier. Computing at the edge delivers quick response but there is limited compute power, whereas computing in the cloud has lot of compute power, but it comes at a cost, due to the pay-per-use cost model (e.g., service level agreements) of cloud computing. Applications which require real-time performance tend to use edge computing for faster response times, but when compute power at the edge falls short (due to increase in application workload), applications can leverage the high performance compute available in the cloud. There can be temporary costs associated to use the cloud resources until the workload reduces.

For microservices-based real-time stream processing applications, dynamically adapting the placement of microservices across edge and cloud computing tiers enables quick response with low cost of operation. However, profiling the application for different workloads on various infrastructures, observing the differences of performance on edge and cloud, and encoding a rule for an optimal placement, can take considerable resources and time due to its complexity and scale.

The present invention solves this problem by leveraging Generative Artificial Intelligence (GenAI) technology. Specifically, Large Language Models (LLM) can be leveraged to dynamically orchestrate placement of application components across edge and cloud computing tiers, in response to changes in application workload, such that insights are delivered quickly with low cost of operation.

The present invention can process real-time microservice data with a limited number of instruction prompts (e.g., 3), written in natural language, to interact with the LLM in order to perform orchestration on the multi-tiered computing infrastructure. The present embodiments can generate instruction prompts that the LLM can easily understand to automatically generate optimal actions for a practical system to automate the task at hand. Additionally, the present embodiments can autonomously generate appropriate models that analyze data and generate optimal actions to achieve faster responses at lower cost for workload changes due to changes in applications for various infrastructures.

Embodiments described herein may be entirely hardware, entirely software or including both hardware and software elements. In a preferred embodiment, the present invention is implemented in software, which includes but is not limited to firmware, resident software, microcode, etc.

Embodiments may include a computer program product accessible from a computer-usable or computer-readable medium providing program code for use by or in connection with a computer or any instruction execution system. A computer-usable or computer readable medium may include any apparatus that stores, communicates, propagates, or transports the program for use by or in connection with the instruction execution system, apparatus, or device. The medium can be magnetic, optical, electronic, electromagnetic, infrared, or semiconductor system (or apparatus or device) or a propagation medium. The medium may include a computer-readable storage medium such as a semiconductor or solid state memory, magnetic tape, a removable computer diskette, a random access memory (RAM), a read-only memory (ROM), a rigid magnetic disk and an optical disk, etc.

Each computer program may be tangibly stored in a machine-readable storage media or device (e.g., program memory or magnetic disk) readable by a general or special purpose programmable computer, for configuring and controlling operation of a computer when the storage media or device is read by the computer to perform the procedures described herein. The inventive system may also be considered to be embodied in a computer-readable storage medium, configured with a computer program, where the storage medium so configured causes a computer to operate in a specific and predefined manner to perform the functions described herein.

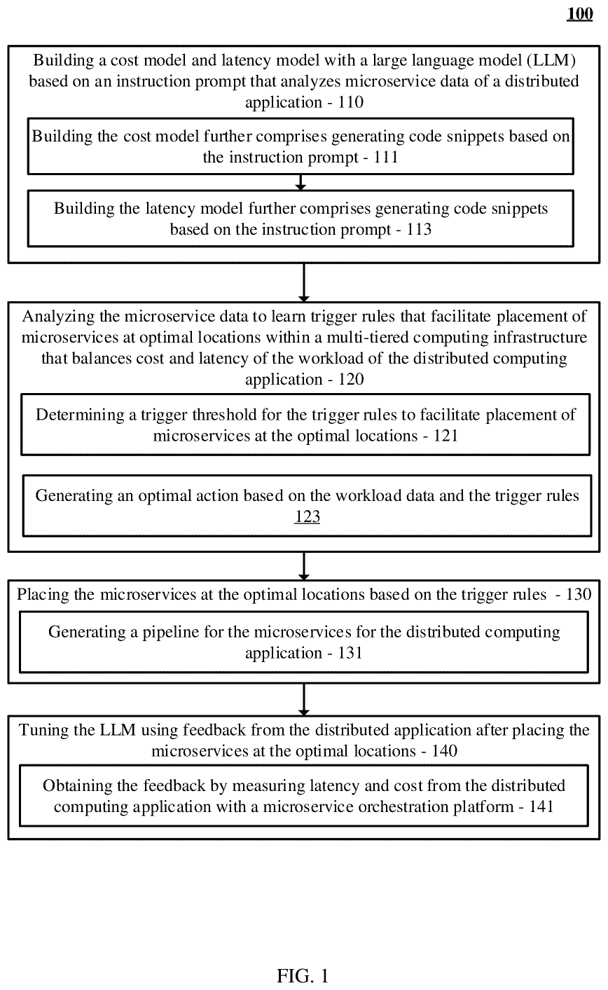

Referring now in detail to the figures in which like numerals represent the same or similar elements and initially to FIG. 1, a flow diagram showing a high-level overview of a computer-implemented method for leveraging large language models for orchestrating microservices, in accordance with an embodiment of the present invention.

In an embodiment, a cost model and a latency model can be built with a large language model (LLM) based on an instruction prompt that analyzes microservice data of a distributed computing application. The microservice data can be analyzed to learn trigger rules that facilitate placement of microservices at optimal locations within the multi-tiered computing infrastructure based on cost and latency. The microservices can be placed at the optimal locations based on the trigger rules. The LLM can be tuned using feedback from the distributed computing application after placing the microservices at the optimal locations.

In block 110, a cost model and a latency model can be built with a large language model (LLM) based on an instruction prompt that analyzes microservice data of a distributed computing application.

The distributed computing application can include the application that users can interact with to perform operations. Examples of distributed computing applications can include web applications, autonomous vehicle systems, robotics systems, internet of things (IoT) devices, smart home devices, etc.

The microservice data can include application data and telemetry data. The application data can include program instructions that can be processed by the distributed computing environment to provide application services to users. The telemetry data can include monitoring data that monitors the status of how the application is provided to users such as latency, application data size, buffer size, service level agreements (SLAs), etc. The microservice data can be obtained by a microservice orchestration platform.

The instruction prompt to the LLM can provide the appropriate information to the LLM to guide it into a specified goal such as making optimal placement decisions. The instruction prompt can provide guidance such as—when to use cloud and when to stay on the edge. Note that this guidance can be generic and is not tied to a particular application or infrastructure. The infrastructure monitor can detect and identify the underlying infrastructure and application. The infrastructure monitor can provide this data to a prompt generator. As such, the guidance given works for any application (e.g., web application, autonomous vehicle applications, distributed computing applications, robotics applications, etc.) and on any connected computer infrastructure such as distributed computing architectures (e.g., hybrid edge/cloud infrastructure, cloud infrastructure, etc.).

The prompt generator can employ heuristics to generate the instruction prompt. The heuristics can include a prompt format that can fit sub-heuristics to enable the prompt generator to generate the instruction prompt for the target LLM. The sub-heuristics can include logic for different parts of the heuristics. The prompt generator can use learned principles of prompt engineering to generate the instruction prompt such that the LLM can play the role of an orchestrator tasked with data-driven placement recommendation that considers latency and cost of operation. The prompt generator can be trained using datasets that can include past instruction prompts. The prompt generator can be trained to perform prompt engineering techniques such as few-shot learning, chain of thought prompting, zero shot prompting, etc. To train the prompt generator, a loss function can be employed using the datasets and a preliminary output of the prompt generator. The prompt generator can then be tuned with optimization techniques such as stochastic gradient descent, etc.

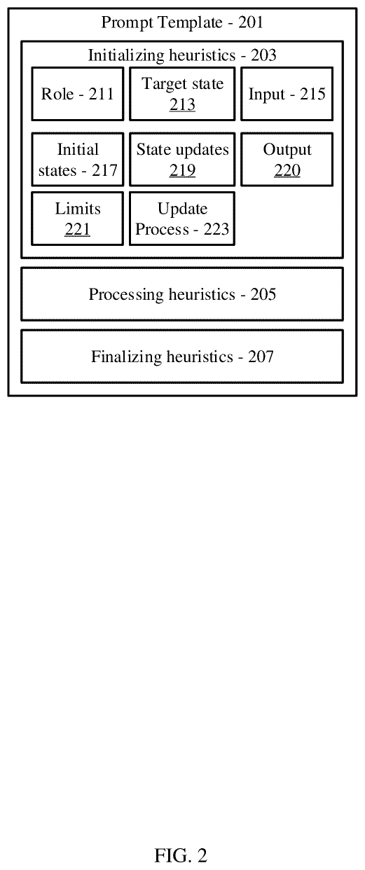

The instruction prompt can give guidance to the LLM on how to build the cost model and the latency model based on the provided latency data. Using the cost and latency models, the guidance includes how the LLM can respond back (along with format specification) with the placement recommendation. Giving such clear prompts enables the LLM to understand the problem and task at hand much better, and is able to comprehend and analyze provided information, and then respond back with high quality output. This is shown in more detail in FIG. 2.

Referring now to FIG. 2, a block diagram showing the relationships between a prompt template, heuristics, and sub-heuristics, in accordance with an embodiment of the present invention.

Prompt template 201 can include heuristics such as initializing heuristics 203, processing heuristics 205, and finalizing heuristics 207. The heuristics can include sub-heuristics that refers to different parts of the heuristic. The sub-heuristics can be generated based on semantic data and syntactical data that can be used by the LLM. The sub-heuristics can include role 211, target state 213, input 215, initial states 217, state updates 219, output 220, limits 221, and update process 223.

In an embodiment, the initializing heuristics, processing heuristics, and finalizing heuristics can have identical sub-heuristics. In another embodiment, the initializing heuristics, processing heuristics, and finalizing heuristics can include varying sub-heuristics.

A first instruction prompt can be generated with the prompt template 201 with the initializing heuristics 203 to instruct the LLM on how to orchestrate microservices based on microservice data obtained. A second instruction prompt can be generated with the prompt template 201 with the processing heuristics 205. A third instruction prompt can be generated with the prompt template 201 with the finalizing heuristics 207.

The second instruction prompt can include a single line prompt, which gives the workload to the LLM and asks for an optimal action. The response given back can be in JSON format with a key (“placement”) and value (“edge” or “cloud”) as instructed in the first instruction prompt.

The third instruction prompt can include a single line prompt, where the latency observed for the recommended placement infrastructure (given in second instruction prompt) is reported back to the LLM. The response indicates that the LLM records the latency, as instructed in the first prompt. This prompt gives feedback to the LLM so that it can know the impact of the optimal action (in response to second instruction prompt). This can help the LLM in refining future actions.

The first instruction prompt can be a one-time prompt given at the start, the second and third instruction prompts can be provided repeatedly (at specified intervals) to the LLM during operation, so that it can make appropriate data-driven placement decisions in real-time.

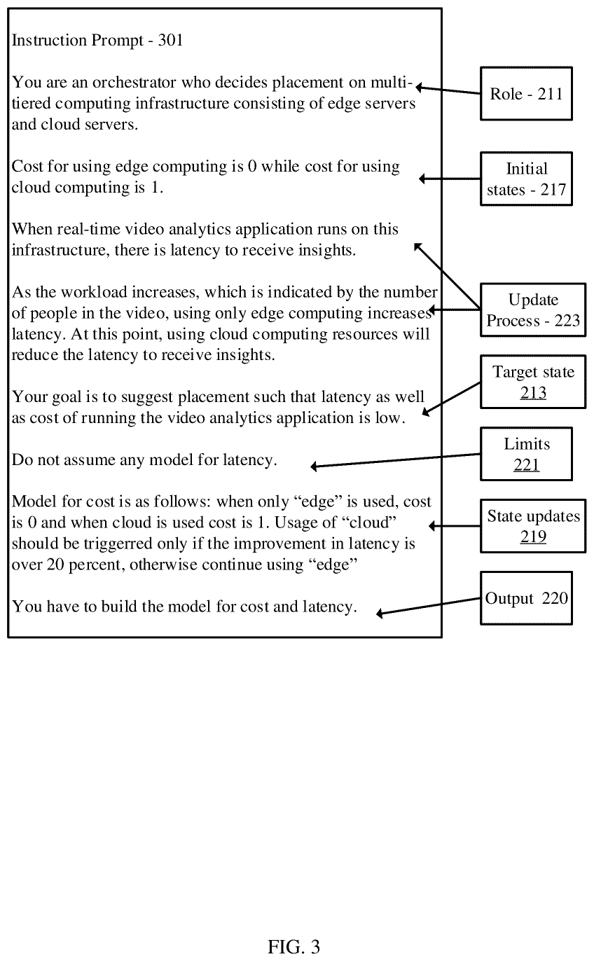

Referring now to FIG. 3, a block diagram showing the relationship between the sub-heuristics and an instruction prompt, in accordance with an embodiment of the present invention.

Parts of the instruction prompt 301 and corresponding sub-heuristics having relationships learned by a prompt generator through training are shown. The arrows correspond to the relationship between the sub-heuristic and a part of the instruction prompt. The prompt generator can be trained using past data including past instruction prompts, past heuristics, datasets, etc.

The instruction prompt can be generated through the prompt generator that can be trained for prompt engineering. The prompt generator can implement a neural network based architecture, multi-layer perceptron (MLP), etc. In another embodiment, the prompt generator can implement an LLM.

The LLM can be ChatGPT™, BERT™, etc. The LLM can include a trained artificial neural network for text processing such as a convolutional neural network, multi-layer perceptron, recurrent neural network, etc.

Referring back now to FIG. 1. In block 111 and 113, code snippets of the cost model and the latency model can be generated by the LLM based on the instruction prompt.

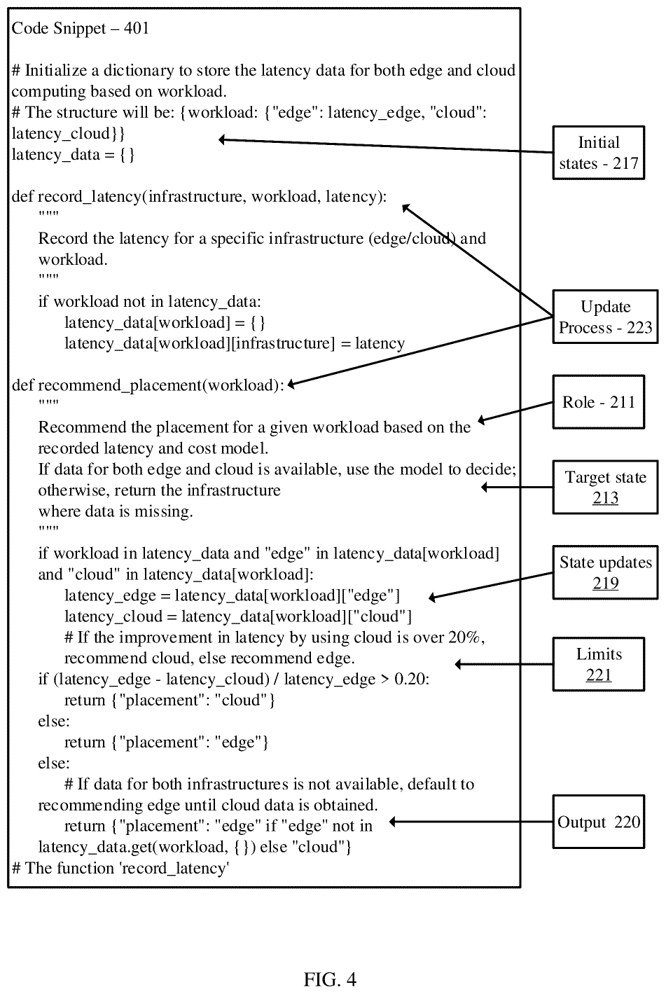

The code snippet can include program code containing logic for the cost model and the latency model. The code snippet can be autonomously generated by the LLM. The LLM can extract the sub-heuristics from the initializing heuristics in the instruction prompt. The LLM can learn corresponding relationships between the sub-heuristic and a corresponding code. Based on the sub-heuristics, the LLM can generate code snippets that correspond to the learned sub-heuristics. This is shown in more detail in FIG. 4.

Referring now to FIG. 4, a block diagram showing the relationship between the sub-heuristics and a code snippet, in accordance with an embodiment of the present invention.

Parts of the code snippet 401 and corresponding sub-heuristics having relationships learned by the LLM are shown. The arrows correspond to the relationship between the sub-heuristic and a part of the code snippet. The LLM can learn the relationships between the sub-heuristic and the corresponding code snippet based on past knowledge due to the clarity and detail of the instruction prompt which filters the past knowledge of the LLM and allows the LLM to understand the intent of the instruction prompt.

The code snippet 401 can be generated using programming languages such as Python™, Java™, C++, PHP, etc.

Referring back now to FIG. 1. In block 120, the microservice data can be analyzed to learn trigger rules that facilitate placement of microservices at optimal locations within the multi-tiered computing infrastructure based on cost and latency.

The LLM can learn the trigger rules based on the recorded latency for each workload and for the various infrastructures for the multi-tiered computing infrastructure. In another embodiment, the trigger rules can include learned rules by a trigger rule analyzer that triggers a change to the states based on the input data which enables the current state after the change to be closer to a desired state.

In another embodiment, the trigger rules can include a trigger threshold that can be compared to status data obtained from the multi-tiered computing infrastructure. Once the trigger threshold is met, the trigger rule activates and the placement at the optimal location can be performed.

The optimal location can include an entity within the multi-tiered computing infrastructure that is determined to have the appropriate conditions for the desired state. For example, in a multi-tiered computing infrastructure, the input application data and infrastructure data as processed generated a result that the edge server is the appropriate location for the application data based on the infrastructure data (e.g., cost, latency, etc.). The optimal location in this example is the edge server.

In block 121, a trigger threshold can be determined for the trigger rules to facilitate placement of microservices at the optimal locations.

The trigger threshold can be a determined state within the multi-tiered computing environment that triggers a desired action such as placing microservices at optimal locations. For example, a distributed computing application such as a video game hosted in the multi-tiered computing infrastructure can have a trigger threshold for latency of 20 milliseconds (ms).

The trigger threshold can be learned by the LLM based on different factors impacting latency of the distributed computing application for different workloads and for different infrastructures. For example, the trigger threshold can be determined based on the dropped packets and data retransmissions for a distributed computing application running on a cloud server which can affect latency.

In another embodiment, the trigger threshold can be learned by a trigger rule analyzer that can utilize neural networks. A correlation between the factors such as dropped packets, data retransmission, and latency can be determined with the trigger rule analyzer. In another embodiment, the correlation between the factors can be computed with statistical computation (e.g., Pearson correlation). In another embodiment, the trigger threshold can be determined based on datasets that can include industry standards, public datasets, historical data, etc.

In block 123, an optimal action can be generated based on a comparison of the microservice data with the trigger threshold.

The optimal action can be generated based on a comparison of the microservice data with the trigger threshold. The optimal action can include program code to perform operations to place the workload data at the optimal location. For example, in a multi-tiered computing infrastructure that can be managed through application programming interface (API) calls, the optimal action can include program code that calls the appropriate API call for placing workload data at a location within the multi-tiered computing infrastructure.

In block 130, the microservices can be placed at the optimal locations based on the trigger rules.

Microservice data can be placed from one location (e.g., server 1) determined to have less optimal properties (e.g., bandwidth, etc.) compared to another (e.g., server 2).

In block 131, a pipeline can be generated for the microservices for the distributed computing application.

A pipeline can be generated for each microservices within the cloud computing environment. The present embodiments can also automatically manage entities (e,g., user devices, server entities, sensors, streams, gadgets, etc.) and connect them through a pipeline. The pipeline can include data management through the entities through a corresponding backend.

To place the microservice to an optimal location, the pipeline for the distributed computing application running in the multi-tiered computing infrastructure can be updated. This automatically triggers re-deployment of the application with the desired mode of placement as updated in the pipeline.

The microservice orchestration platform can continue to operate and manage placement of microservices as long as the pipeline is running. When the pipeline is removed, the microservice orchestration platform removes the corresponding application microservices e.g., sensors, streams, gadgets, and then finally, the microservice orchestration platform also removes corresponding backend. Thus, the lifecycle of starts with registration of a pipeline on the microservice orchestration platform and ends with its removal.

In block 140, the LLM can be tuned using feedback from the distributed computing application after placing the microservices at the optimal locations.

To tune the LLM, the feedback, the optimal action, the microservice data can be stored in a database and provided to the LLM. The feedback provides the LLM with an impact of the optimal action based on the microservice data and can allow it to tailor its responses to the instruction prompts.

In another embodiment, the prompt generator and the trigger rule analyzer can be fine-tuned with the feedback using an optimization process such as stochastic gradient descent, etc.

In block 141, feedback can be obtained by measuring latency and cost from the distributed computing application with a microservice orchestration platform.

The present embodiments can analyze the microservice data, place the microservices, and tune the LLM continuously in real-time to incrementally tune the LLM with newly obtained feedback after placing the microservices at the optimal locations based on the trigger rules.

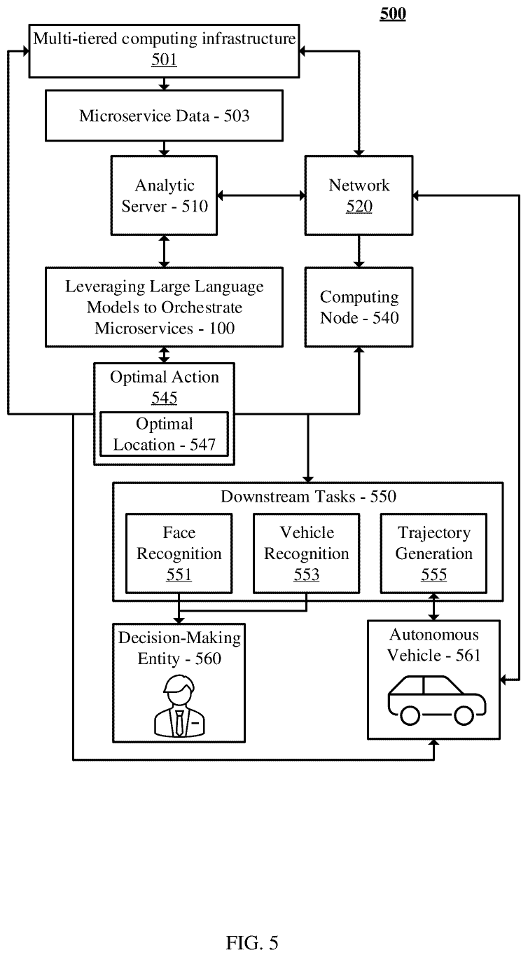

Referring now to FIG. 5, a block diagram showing a system for leveraging large language models for orchestrating microservices implemented in practical applications, in accordance with an embodiment of the present invention.

In system 500, a multi-tiered computing infrastructure 501 can be monitored which can perform downstream tasks 550 that includes face recognition 551, vehicle recognition 553, and trajectory generation 555. Microservice data 503 for the downstream tasks 550 can be obtained from the multi-tiered computing infrastructure 501. The microservice data 503 can be provided to an analytic server 510 through a network 520 that can implement leveraging large language models to orchestrate microservices 100 to generate an optimal action 545. The optimal action 545 can be provided to the computing node 540 that users can interact with.

In face recognition 551, multiple entities (e.g., people) can be monitored for identification within a specific location. To monitor the multiple entities, a machine learning-based system trained for image processing can be employed. As the entities increase, the amount of microservice data 503 increases, which affects cost and latency. To handle such increase, optimal action 545 can be generated by the system 500 to balance the workload for face recognition 551 by placing microservice data 503 at the optimal location 547. The identified entities can be sent to assist the decision-making process (e.g., surveillance, security, statistics, etc.) of a decision-making entity 560.

In vehicle recognition 553, multiple entities (e.g. vehicles) can be monitored for identification within a specific location. To monitor the multiple entities, a machine learning-based system trained for image processing can be employed. As the entities increase, the amount of microservice data 503 increases, which affects cost and latency. To handle such increase, optimal action 545 can be generated by the system 500 to balance the workload for vehicle recognition 553 by placing microservice data 503 at the optimal location 547. The identified entities can be sent to assist the decision-making process (e.g., surveillance, security, statistics, etc.) of a decision-making entity 560.

In trajectory generation 555, a traffic scene can be reconstructed by an autonomous vehicle 561 that communicates with an analytic server 510 that can implement a image-processing machine learning system. The analytic server 510 can then generate a trajectory within the traffic scene which can be used to control the autonomous vehicle 561. The traffic scene can include multiple entities (e.g., pedestrians, traffic signs, vehicles, road signs, etc.) which can vary in number as time progresses. This change in the number of entities can affect the microservice data 503 which then affects cost, latency and effectiveness of the trajectory generated. To handle such change, optimal action 545 can be generated by the system to balance the workload for trajectory generation 555 by placing microservice data 503 at the optimal location 547.

In another embodiment of trajectory generation 555, a traffic scene can be reconstructed by an autonomous vehicle 561 that communicates with an analytic server 510 that can implement an image-processing machine learning system. The system 500 can generate a trajectory within the traffic scene which can be used to control the autonomous vehicle 561 using input data (e.g., images, light and detection ranging (LIDAR), radio detection and ranging (RADAR)) obtained from sensors. The sensors can be mounted on the autonomous vehicle 561 which can provide real-time input data. The system 500 can leverage the LLM to generate models for image processing, adverse learning, reinforcement learning, etc. to generate the trajectory models. Based on the generated models, the system 500 can generate a trajectory for the automated vehicle 561 in real-time. The trajectory can then be utilized to control the automated vehicle 561 through the automated vehicles automated propulsion systems, advanced driver assistance systems, etc. The system 500 can be utilized to generate appropriate models for other practical applications (e.g., face recognition, vehicle recognition, etc.).

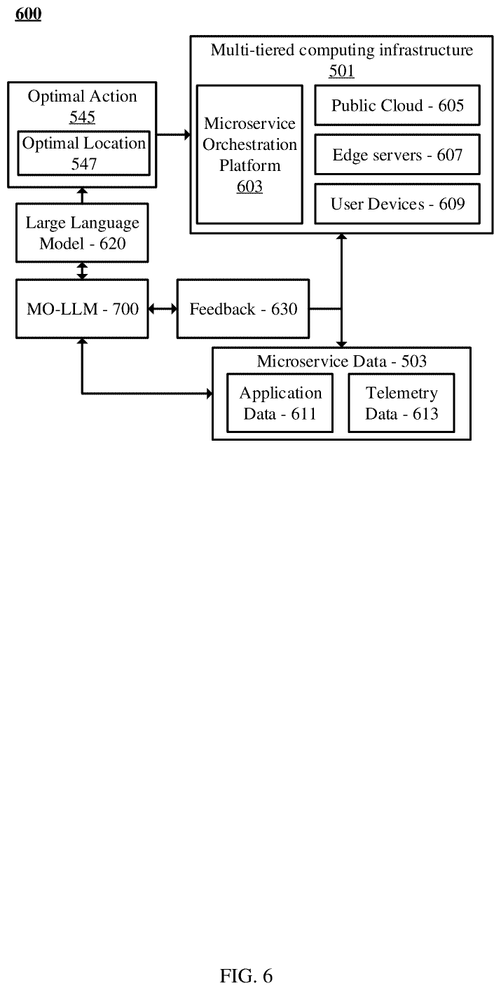

Referring now to FIG. 6, a block diagram showing an overview of a system for leveraging large language models for orchestrating microservices, in accordance with an embodiment of the present invention.

In system 600, a multi-tiered computing infrastructure 501 can include a public cloud 605, edge servers 607, and user devices 609. A microservice orchestration platform 603 can obtain microservice data 503 from the multi-tiered computing infrastructure 501. The microservice data 503 can include application data 611 and telemetry data 613. The microservice data 503 can be processed by a computer system that implements leveraging large language models for orchestrating microservices (MO-LLM) 700 and generate an optimal action 545 by employing a large language model 620. The optimal action 545 can orchestrate microservice data 503 at the optimal location 547 (e.g., public cloud 605, edge servers 607, user devices 609) based on cost and latency. A feedback 630 can be obtained from the multi-tiered computing infrastructure 501 that can be used to tune the large language model 620 and the MO-LLM 700.

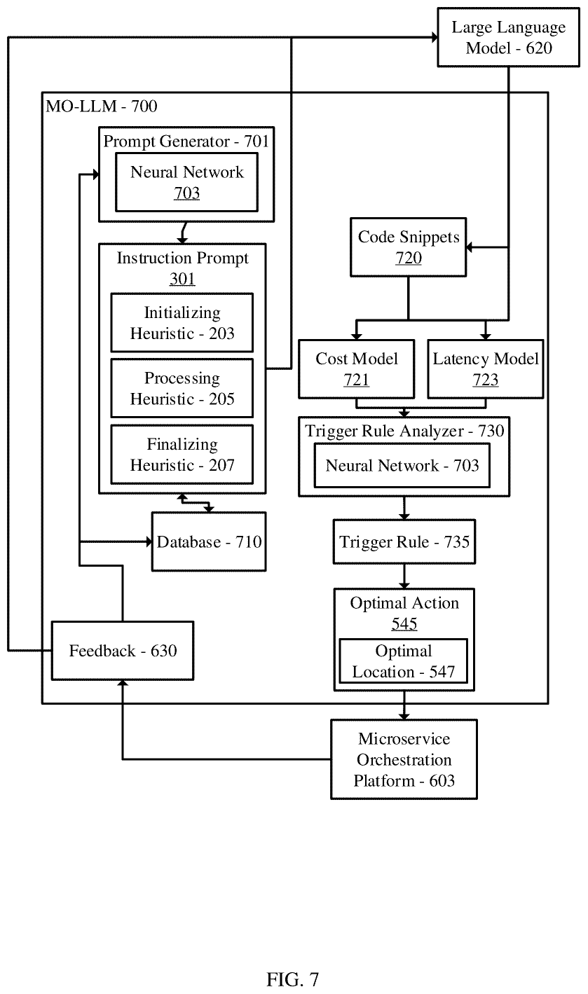

Referring now to FIG. 7, a block diagram showing a system for leveraging large language models for orchestrating microservices (MO-LLM), in accordance with an embodiment of the present invention.

In MO-LLM 700, a prompt generator 701 can be employed to generate an instruction prompt 301. The prompt generator 701 can utilize a neural network 703. The instruction prompt 301 can include heuristics such as initializing heuristic 203, processing heuristic 205, and finalizing heuristic 207. The instruction prompt 301, the heuristics, the code snippets 720 can be stored in a database 710.

The instruction prompt 301 can be provided to the large language model (LLM) 620 to guide the LLM 620 to generate code snippets 720 of a cost model 721 and latency model 723. The cost model 721 and latency model 723 can be processed by the LLM to record microservice data and generate optimal action 545 that can include an optimal location 547 based on the recorded microservice data, the cost model 721 and the latency model 723. The LLM 620 can learn trigger rules, based on the instruction prompt 301, that facilitate the generation of an optimal action 545 that can include an optimal location 547.

In another embodiment, the cost model 721 and latency model 723 can be processed by a trigger rule analyzer 730 to learn and understand trigger rules 735 that facilitate the generation of an optimal action 545 that can include an optimal location 547. The trigger rule analyzer 730 can also utilize a neural network 703.

The optimal action 545 can be processed by a microservice orchestration platform 603 to orchestrate microservices at the optimal location 547 within a multi-tiered computing infrastructure 501.

A feedback 630 can be obtained from the microservice orchestration platform which details the impact of the optimal action 545 to the multi-tiered computing infrastructure 501 that provides service to run a distributed computing application. The feedback 630 can be provided to the prompt generator 701, the trigger rule analyzer 730, and LLM 620 to tune them.

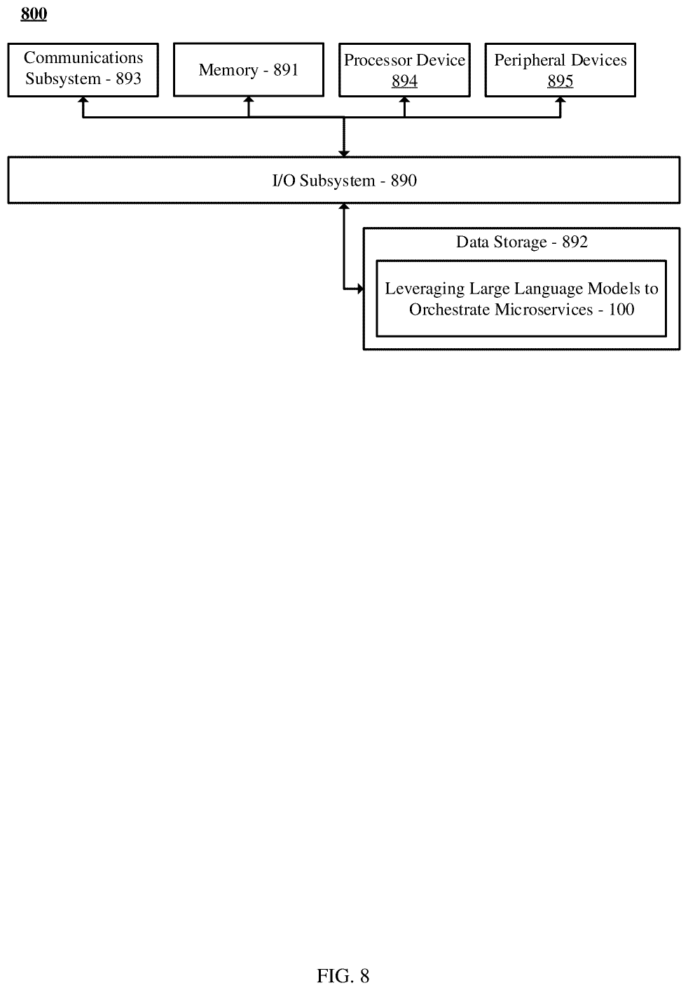

Referring now to FIG. 8, a block diagram showing a computer system for leveraging large language models for orchestrating microservices, in accordance with an embodiment of the present invention.

The computing device 800 illustratively includes the processor device 894, an input/output (I/O) subsystem 890, a memory 891, a data storage device 892, and a communication subsystem 893, and/or other components and devices commonly found in a server or similar computing device. The computing device 800 may include other or additional components, such as those commonly found in a server computer (e.g., various input/output devices), in other embodiments. Additionally, in some embodiments, one or more of the illustrative components may be incorporated in, or otherwise form a portion of, another component. For example, the memory 891, or portions thereof, may be incorporated in the processor device 894 in some embodiments.

The processor device 894 may be embodied as any type of processor capable of performing the functions described herein. The processor device 894 may be embodied as a single processor, multiple processors, a Central Processing Unit(s) (CPU(s)), a Graphics Processing Unit(s) (GPU(s)), a single or multi-core processor(s), a digital signal processor(s), a microcontroller(s), or other processor(s) or processing/controlling circuit(s).

The memory 891 may be embodied as any type of volatile or non-volatile memory or data storage capable of performing the functions described herein. In operation, the memory 891 may store various data and software employed during operation of the computing device 800, such as operating systems, applications, programs, libraries, and drivers. The memory 891 is communicatively coupled to the processor device 894 via the I/O subsystem 890, which may be embodied as circuitry and/or components to facilitate input/output operations with the processor device 894, the memory 891, and other components of the computing device 800. For example, the I/O subsystem 890 may be embodied as, or otherwise include, memory controller hubs, input/output control hubs, platform controller hubs, integrated control circuitry, firmware devices, communication links (e.g., point-to-point links, bus links, wires, cables, light guides, printed circuit board traces, etc.), and/or other components and subsystems to facilitate the input/output operations. In some embodiments, the I/O subsystem 890 may form a portion of a system-on-a-chip (SOC) and be incorporated, along with the processor device 894, the memory 891, and other components of the computing device 800, on a single integrated circuit chip.

The data storage device 892 may be embodied as any type of device or devices configured for short-term or long-term storage of data such as, for example, memory devices and circuits, memory cards, hard disk drives, solid state drives, or other data storage devices. The data storage device 892 can store program code for leveraging large language models for orchestrating microservices 100. Any or all of these program code blocks may be included in a given computing system.

The communication subsystem 893 of the computing device 800 may be embodied as any network interface controller or other communication circuit, device, or collection thereof, capable of enabling communications between the computing device 800 and other remote devices over a network. The communication subsystem 893 may be configured to employ any one or more communication technology (e.g., wired or wireless communications) and associated protocols (e.g., Ethernet, InfiniBand®, Bluetooth®, Wi-Fi®, WiMAX, etc.) to effect such communication.

As shown, the computing device 800 may also include one or more peripheral devices 895. The peripheral devices 895 may include any number of additional input/output devices, interface devices, and/or other peripheral devices. For example, in some embodiments, the peripheral devices 895 may include a display, touch screen, graphics circuitry, keyboard, mouse, speaker system, microphone, network interface, and/or other input/output devices, interface devices, GPS, camera, and/or other peripheral devices.

Of course, the computing device 800 may also include other elements (not shown), as readily contemplated by one of skill in the art, as well as omit certain elements. For example, various other sensors, input devices, and/or output devices can be included in computing device 800, depending upon the particular implementation of the same, as readily understood by one of ordinary skill in the art. For example, various types of wireless and/or wired input and/or output devices can be employed. Moreover, additional processors, controllers, memories, and so forth, in various configurations can also be utilized. These and other variations of the computing device 800 are readily contemplated by one of ordinary skill in the art given the teachings of the present invention provided herein.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

As employed herein, the term “hardware processor subsystem” or “hardware processor” can refer to a processor, memory, software or combinations thereof that cooperate to perform one or more specific tasks. In useful embodiments, the hardware processor subsystem can include one or more data processing elements (e.g., logic circuits, processing circuits, instruction execution devices, etc.). The one or more data processing elements can be included in a central processing unit, a graphics processing unit, and/or a separate processor- or computing element-based controller (e.g., logic gates, etc.). The hardware processor subsystem can include one or more on-board memories (e.g., caches, dedicated memory arrays, read only memory, etc.). In some embodiments, the hardware processor subsystem can include one or more memories that can be on or off board or that can be dedicated for use by the hardware processor subsystem (e.g., ROM, RAM, basic input/output system (BIOS), etc.).

In some embodiments, the hardware processor subsystem can include and execute one or more software elements. The one or more software elements can include an operating system and/or one or more applications and/or specific code to achieve a specified result. In other embodiments, the hardware processor subsystem can include dedicated, specialized circuitry that performs one or more electronic processing functions to achieve a specified result. Such circuitry can include one or more application-specific integrated circuits (ASICs), field-programmable gate arrays (FPGAs), and/or programmable logic arrays (PLAs). These and other variations of a hardware processor subsystem are also contemplated in accordance with embodiments of the present invention.

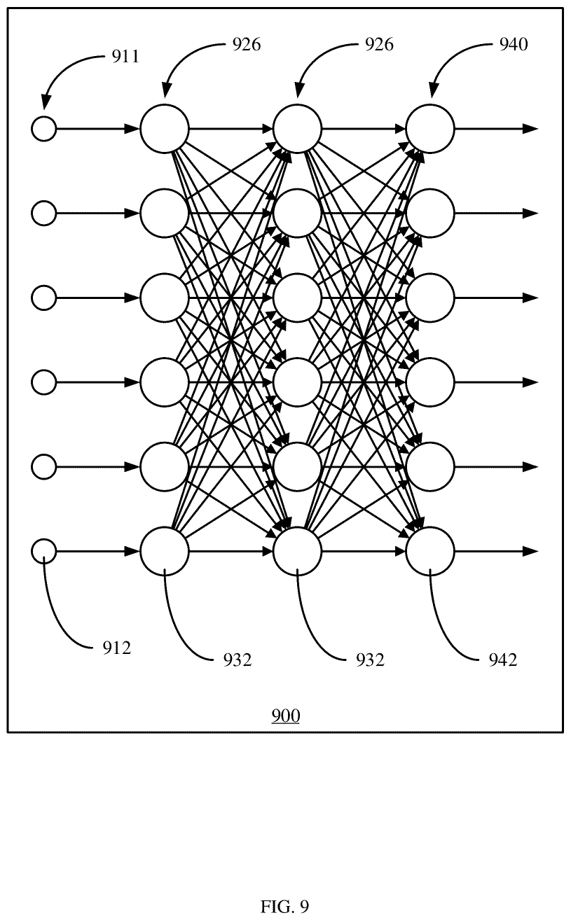

Referring now to FIG. 9, a block diagram showing a structure of deep neural networks for leveraging large language models for orchestrating microservices, in accordance with an embodiment of the present invention.

A neural network is a generalized system that improves its functioning and accuracy through exposure to additional empirical data. The neural network becomes trained by exposure to the empirical data. During training, the neural network stores and adjusts a plurality of weights that are applied to the incoming empirical data. By applying the adjusted weights to the data, the data can be identified as belonging to a particular predefined class from a set of classes or a probability that the inputted data belongs to each of the classes can be output.

The empirical data, also known as training data, from a set of examples can be formatted as a string of values and fed into the input of the neural network. Each example may be associated with a known result or output. Each example can be represented as a pair, (x, y), where x represents the input data and y represents the known output. The input data may include a variety of different data types and may include multiple distinct values. The network can have one input neurons for each value making up the example's input data, and a separate weight can be applied to each input value. The input data can, for example, be formatted as a vector, an array, or a string depending on the architecture of the neural network being constructed and trained.

The neural network “learns” by comparing the neural network output generated from the input data to the known values of the examples and adjusting the stored weights to minimize the differences between the output values and the known values. The adjustments may be made to the stored weights through back propagation, where the effect of the weights on the output values may be determined by calculating the mathematical gradient and adjusting the weights in a manner that shifts the output towards a minimum difference. This optimization, referred to as a gradient descent approach, is a non-limiting example of how training may be performed. A subset of examples with known values that were not used for training can be used to test and validate the accuracy of the neural network.

During operation, the trained neural network can be used on new data that was not previously used in training or validation through generalization. The adjusted weights of the neural network can be applied to the new data, where the weights estimate a function developed from the training examples. The parameters of the estimated function which are captured by the weights are based on statistical inference.

The deep neural network 900, such as a multilayer perceptron, can have an input layer 911 of source neurons 912, one or more computation layer(s) 926 having one or more computation neurons 932, and an output layer 940, where there is a single output neuron 942 for each possible category into which the input example could be classified. An input layer 911 can have a number of source neurons 912 equal to the number of data values 912 in the input data 911. The computation neurons 932 in the computation layer(s) 926 can also be referred to as hidden layers, because they are between the source neurons 912 and output neuron(s) 942 and are not directly observed. Each neuron 932, 942 in a computation layer generates a linear combination of weighted values from the values output from the neurons in a previous layer, and applies a non-linear activation function that is differentiable over the range of the linear combination. The weights applied to the value from each previous neuron can be denoted, for example, by w₁, w₂, . . . wₙ₋₁, wₙ. The output layer provides the overall response of the network to the inputted data. A deep neural network can be fully connected, where each neuron in a computational layer is connected to all other neurons in the previous layer, or may have other configurations of connections between layers. If links between neurons are missing, the network is referred to as partially connected.

In an embodiment, the computation layers 926 of the neural network 703 utilized in the prompt generator 701 can learn corresponding relationships between the sub-heuristics, heuristics, and the prompt template 201 to generate an instruction prompt 301 as the output of the output layer of the neural network 703. The neural network 703 utilized in the prompt generator can also learn prompt engineering to generate the instruction prompt 301.

In an embodiment, the computation layers 926 of the neural network 703 utilized in the trigger rule analyzer 730 can learn corresponding relationships between the microservice data, the sub-heuristics, and code snippets 720 to learn a trigger rule 735 as the output of the output layer of the neural network 703.

In an embodiment, based on the sub-heuristics, the LLM 620 can autonomously generate code snippets 720 that correspond to the learned sub-heuristics. In an embodiment, the computation layers 926 of the LLM 620 can learn corresponding relationships between the sub-heuristic and a corresponding code snippet 720. Based on the sub-heuristics, the LLM 620 can autonomously generate code snippets 720 that correspond to the learned sub-heuristics.

Training a deep neural network can involve two phases, a forward phase where the weights of each neuron are fixed and the input propagates through the network, and a backwards phase where an error value is propagated backwards through the network and weight values are updated. The computation neurons 932 in the one or more computation (hidden) layer(s) 926 perform a nonlinear transformation on the input data 912 that generates a feature space. The classes or categories may be more easily separated in the feature space than in the original data space.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment. However, it is to be appreciated that features of one or more embodiments can be combined given the teachings of the present invention provided herein.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended for as many items listed.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the present invention and that those skilled in the art may implement various modifications without departing from the scope and spirit of the invention. Those skilled in the art could implement various other feature combinations without departing from the scope and spirit of the invention. Having thus described aspects of the invention, with the details and particularity required by the patent laws, what is claimed and desired protected by Letters Patent is set forth in the appended claims.

What is claimed is:

1. A computer-implemented method for leveraging large language models to orchestrate microservices, comprising:
building a cost model and a latency model by employing a large language model (LLM) based on an instruction prompt that analyzes microservice data of a distributed computing application;
analyzing the microservice data with the cost model and the latency model to learn trigger rules that facilitate placement of microservices at optimal locations within a multi-tiered computing infrastructure that balances cost and latency of a workload of the distributed computing application;
placing the microservices at the optimal locations based on the trigger rules; and
tuning the LLM using feedback from the distributed computing application after placing the microservices at the optimal locations.

2. The computer-implemented method of claim 1, further comprising balancing workloads of a vehicle recognition system implemented within a multi-tiered computing infrastructure.

3. The computer-implemented method of claim 1, wherein building the cost model further comprises generating code snippets autonomously based on the instruction prompt.

4. The computer-implemented method of claim 1, wherein building the latency model further comprises generating code snippets autonomously based on the instruction prompt.

5. The computer-implemented method of claim 1, wherein analyzing the microservice data further comprises determining a trigger threshold for the trigger rules to facilitate placement of microservices at the optimal locations.

6. The computer-implemented method of claim 1, wherein analyzing the microservice data further comprises generating an optimal action based on the workload data and the trigger rules.

7. The computer-implemented method of claim 1, wherein tuning the LLM further comprises obtaining the feedback by measuring latency and cost from the distributed computing application with a microservice orchestration platform.

8. A system for leveraging large language models to orchestrate microservices, comprising:
a memory device;
one or more processor devices operatively coupled with the memory device to perform operations including:
building a cost model and a latency model by employing a large language model (LLM) based on an instruction prompt that analyzes microservice data of a distributed computing application;
analyzing the microservice data with the cost model and the latency model to learn trigger rules that facilitate placement of microservices at optimal locations within a multi-tiered computing infrastructure that balances cost and latency of a workload of the distributed computing application;
placing the microservices at the optimal locations based on the trigger rules; and
tuning the LLM using feedback from the distributed computing application after placing the microservices at the optimal locations.

9. The system of claim 8, further comprising balancing workloads of a vehicle recognition system implemented within a multi-tiered computing infrastructure.

10. The system of claim 8, wherein building the cost model further comprises generating code snippets autonomously based on the instruction prompt.

11. The system of claim 8, wherein building the latency model further comprises generating code snippets autonomously based on the instruction prompt.

12. The system of claim 8, wherein analyzing the microservice data further comprises determining a trigger threshold for the trigger rules to facilitate placement of microservices at the optimal locations.

13. The system of claim 8, wherein analyzing the microservice data further comprises generating an optimal action based on the workload data and the trigger rules.

14. The system of claim 8, wherein tuning the LLM further comprises obtaining the feedback by measuring latency and cost from the distributed computing application with a microservice orchestration platform.

15. A non-transitory computer program product comprising a computer-readable storage medium including a program code, wherein the program code when executed on a computer causes the computer to perform:
building a cost model and a latency model by employing a large language model (LLM) based on an instruction prompt that analyzes microservice data of a distributed computing application;
analyzing the microservice data with the cost model and the latency model to learn trigger rules that facilitate placement of microservices at optimal locations within a multi-tiered computing infrastructure that balances cost and latency of a workload of the distributed computing application;
placing the microservices at the optimal locations based on the trigger rules; and
tuning the LLM using feedback from the distributed computing application after placing the microservices at the optimal locations.

16. The non-transitory computer program product of claim 15, further comprising balancing workloads of a vehicle recognition system implemented within a multi-tiered computing infrastructure.

17. The non-transitory computer program product of claim 15, wherein building the cost model further comprises generating code snippets autonomously based on the instruction prompt.

18. The non-transitory computer program product of claim 15, wherein building the latency model further comprises generating code snippets autonomously based on the instruction prompt.

19. The non-transitory computer program product of claim 15, wherein analyzing the microservice data further comprises determining a trigger threshold for the trigger rules to facilitate placement of microservices at the optimal locations.

20. The non-transitory computer program product of claim 15, wherein analyzing the microservice data further comprises generating an optimal action based on the workload data and the trigger rules.
